(19) United States
(12) Patent Application Publication
(10) Pub. No.: US 2016/0012511 A1
(43) Pub. Date: Jan. 14, 2016

(54) METHODS AND SYSTEMS FOR GENERATING RECOMMENDATION LIST WITH DIVERSITY

(71) Applicant: KOBO Incorporated, Toronto (CA)

(72) Inventors: Darius BRAZIUNAS, Toronto (CA); Jordan CHRISTENSEN, Toronto (CA)

(21) Appl. No.: 13/926,999

(22) Filed: Jun. 25, 2013

(51) Int. Cl. G06Q 30/06; G06Q 30/02; G06F 17/30

(52) U.S. Cl. CPC G06Q 30/0631; G06F 17/30598; G06F 17/30584; G06Q 30/0255

(57) ABSTRACT

Systems and methods for automatically generating a user-specific recommendation list with diversified as well as relevant items. Recommendation categories and sample items for each category are diversified by virtue of probability distribution. Items in a user' collection can be clustered based on category in accordance with a similarity measure. The category probability distribution values may be derived from characteristics suggesting respective categories' importance or preference to the user. For each selected category, the sample probability distribution values may be derived from similarities of each candidate to the selected category.

### TECHNICAL FIELD

The present disclosure relates generally to the field of e-commerce marketing, and, more specifically, to the field of automatic generation of recommendation items.

### BACKGROUND

Presenting customized recommendation lists of relevant products based on individual consumers' shopping behavior patterns has become increasingly important for e-commerce companies in order for them to effectively attract and retain consumers. Many of the recommendation systems have adopted Collaborative Filtering (CF) approaches in which recommendations are made based on a user's manifested preferences, e.g., satisfactory ratings, on particular products.

A typical CF recommendation generation process in accordance with the prior art primarily comprises steps as follows. Let U be the set of all users, and I be the set of all items. Let Iu be the set of items that have been purchased or rated or commented on by user u ∈ U. For example, Iu may correspond to a user's library or collection of books. Then each item i in the user's library is weighted according to its type (where type is either a purchase, or feedback, or rating); the weight w_{i,u} can also depend on the time the item was added to the library. Given a similarity function s, the potential set of recommended items Rᵤ is computed by scoring every item in I and selecting those with highest scores that are not already in the user library Iu. The scoring function rᵤ (i) is simply a weighted sum of similarities between items in the user's library and a given item i, e.g.

$${T}_{u} ( i ) = {\sum }_{j ∈ {I}_{u}} {w}_{j , u} s ( j , i ) .$$

As demonstrated by the above equation, the evaluation metrics in conventional CF recommendation systems only consider the relevancy of each recommendation in isolation. Therefore, although these systems can make recommendations on products closely relevant to user's prior individual purchases, the recommendation lists lack ˜diversity as well as other global measures that may be useful to influence a user's interest of purchasing. As an unfortunate result, a user likely receives very similar or even the same list repeatedly and the distribution may become stale. Existing efforts directed to introduce diversification to recommendations are quite ad-hoc at a cost of recommendation performance.

### SUMMARY OF THE INVENTION

It would be advantageous to provide a mechanism of automatically generating user-specific recommendation lists with diversified as well as relevant items based on a user's past behavior. Accordingly, embodiments of the present disclosure employ computer implemented methods of stochastically selecting recommendation categories for a recommendation list based on a user's manifested preference on categories, and further stochastically selecting items for each recommendation category based on a similarity measure. Commodities in a user' collection can be clustered based on category in accordance with a similarity measure. A set of recommendation categories can be selected for a recommendation instance based on respective category probability distribution values assigned to the clusters in the user's collection. The category probability distribution values may correspond to respective categories' importance or preference to the user. Moreover, for each selected category, sample commodities are selected from a list of candidates based on respective sample probability distribution values assigned to the list of candidates. The sample probability distribution values may be derived from similarities of each candidate to the selected category. Thereby the resultant recommendation lists advantageously encompass diversified categories and diversified samples in each selected category while preserve the relevancy of the recommended samples to a user's collection.

In one embodiment of the present disclosure, a computer implemented method of automatically generating a recommendation list of commodities comprises: (1) accessing a user inventory comprising a collection of commodities in a plurality of categories of commodities; (2) partitioning the collection of commodities into a plurality of clusters of commodities, each cluster corresponding to a respective category of the plurality of categories; (3) assigning respective probability distribution values to the plurality of categories; (4) determining a selection set of categories from the plurality of categories for a recommendation instance based on probability distribution values of the plurality categories; (5) determining a respective sample commodity for each category of the selection set of categories to produce a plurality of sample recommendations, wherein the plurality of sample recommendations are selected from a stock of commodities; and (6) presenting the recommendation list identifying the plurality of sample commodities for the selection set of categories. The probability distribution values may be converted from weight factors indicating a user's tendency of accessing commodities in a category. The collection of commodities may be partitioned in accordance with similarities by use of a cluster algorithm. Recommendation probability values may be assigned to candidate sample commodities in accordance with similarities between an item and a category. Respective sample commodities can be selected stochastically from the candidate sample commodities in accordance with recommendation probabilities assigned thereto respectively.

In another embodiment of present disclosure, a non-transitory computer-readable storage medium embodying instructions that, when executed by a processing device, cause the processing device to perform a method of creating a recommendation list of commodities to a user, the method comprising: (1) accessing a user inventory comprising a collection of commodities; (2) accessing a stock of commodities; (3) identifying a plurality of categories associated with the collection of commodities; (4) stochastically selecting a set of categories from the plurality of categories for a recommendation event in accordance with a first probability distribution; (5) stochastically selecting respective selected commodities for each category in the set of categories for the recommendation event in accordance with a second probability distribution; and (6) during the recommendation event, presenting the recommendation list identifying selected commodities selected for the set of categories through a recommendation channel.

In another embodiment of present disclosure, a system comprising: a processor; a memory coupled to the processor and comprising instructions that, when executed by the processor, cause the processor to perform a method of determining recommendations of books with diversification, the method comprising: (1) accessing an inventory of a user library comprising a collection of books; (2) accessing an inventory of a stock of books; (3) partitioning the collection of books into a plurality of clusters of books, each cluster corresponding to a respective topic; (4) assigning a respective category probability distribution value to each topic of the collection of books; (5) selecting a plurality of sample topics for a recommendation instance based on respective category probability distribution values assigned for topics of the collection of books;(6) selecting respective sample books from the stock of books for each sample topic for the recommendation instance; and (7) during the recommendation instance, presenting a recommendation list identifying sample books for the plurality of sample topics.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 depicts an exemplary process of generating recommendation lists with diversified categories and diversified samples by virtue of probability distribution in accordance with an embodiment of the present disclosure.

FIG. 2 is a flow chart depicting an exemplary computer implemented method of generating a recommendation list by virtue of diversifying category selections and diversifying sample selections in accordance with an embodiment of the present disclosure.

FIG. 3 is a flow chart illustrating an exemplary computer implemented method of selecting recommendation topics by virtue of probability distribution in accordance with an embodiment of the present disclosure.

FIG. 4 is a flow chart illustrating an exemplary computer implemented method of instantiating recommendation items for each selected topic by virtue of probability distribution that is determined based on similarities in accordance with an embodiment of the present disclosure.

FIG. 5 is a diagram illustrating an exemplary on-screen graphic user interface (GUI) that presents a recommendation list with diversified topics and diversified sample items in accordance with an embodiment of the present disclosure.

FIG. 6 is a block diagram illustrating an exemplary computing system including an automatic recommendation list generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Methods and Systems for Generating Recommendation List with Diversity

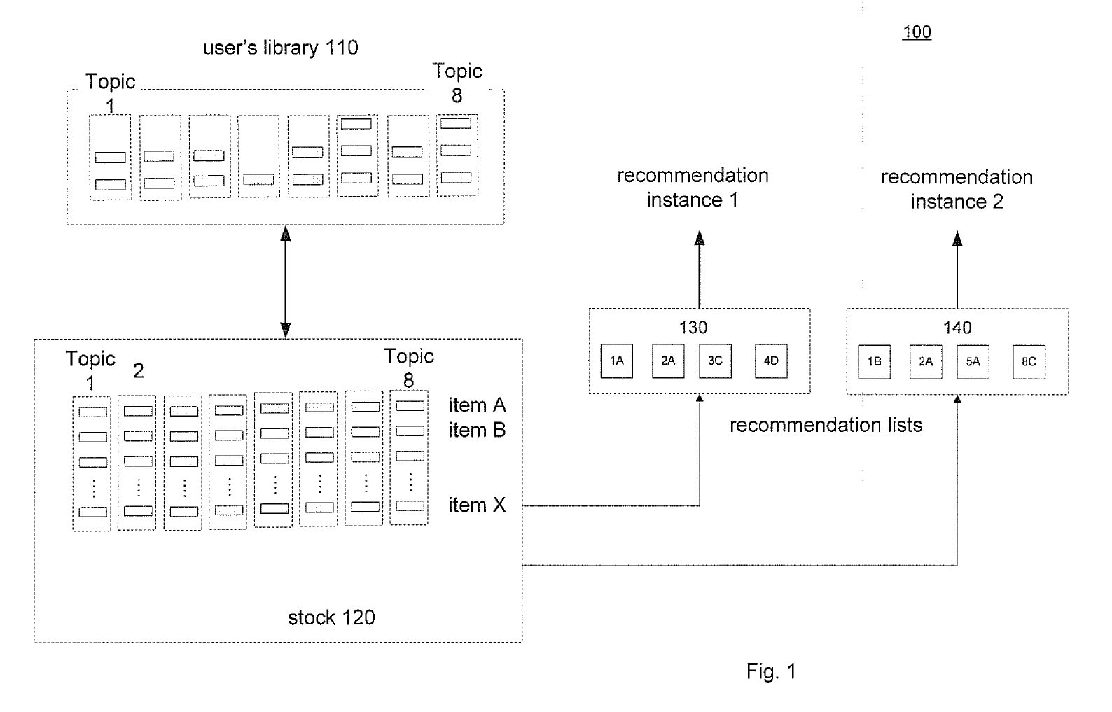

FIG. 1 depicts an exemplary process 100 of generating recommendation lists with diversified categories and diversified samples by virtue of probability distribution in accordance with an embodiment of the present disclosure. For illustrative purposes, in this embodiment, the user's collection 110 (or the user's library), and the stock 120 only include books. However the processes and systems of the present invention can be applied to any item of commerce, etc. Overall, the information related to the user's library 100 is analyzed and utilized to automatically selected books from the stock 120 to generate recommendation lists 130 and 140 for corresponding recommendation instances. In this embodiment, the recommendation lists presented is limited to 4 books for each instance, e.g., by the application program rendering the recommendation channel.

Based on relatedness of the books within the library, the book items in the library 110 can be clustered into a number of groups by topic category. In this example, the books in the library 110 are clustered into 8 topics, each of the 8 topics including 1 to 3 books. In contrast to selecting recommendation topics in a deterministic manner, each topic in the library 110 is assigned with a respective probability distribution value and thus the topic is selected in accordance with the assigned probability in a particular recommendation list, e.g. 130 or 140. In some embodiments, the probability distribution values are determined based on respective importance (e.g., by the number of items in a cluster or the price of the items, etc.) of corresponding topics to a user. Therefore, diversified topics pertaining to a user's interests are advantageously included in the recommendation lists, which can broaden the scope of recommendations to a user receiving the list and thereby enhances potential business opportunities.

After identification of recommendation topics for a certain recommendation list, each topic is instantiated with one or more sample books selected from the stock 120 based on similarities between the topic and books in the stock 120. In other words, sample books can be selected from a list of closest items identified from the stock 120 e.g. 121, 122, or 128, in accordance with any suitable selection mechanism. In some embodiments, the selection may be based solely on relevancy in a deterministic manner. As will be discussed in greater details, in some other embodiments, sample books in each selected topic can be stochastically selected from the closest books to the topic in accordance with another probability distribution so as to diversify the items for each topic on the recommendation list. By the same token, stochastically selected sample books in each selected topic advantageously offer additional diversification to the recommendation list, and further broadens the scope of recommendations and enhances potential business opportunities.

As shown in FIG. 1, corresponding to the 8 topics in the user's library 110, closest items for each topic are identified from the stock 120. For instance, with reference to topic 8, the closest items are item 8A, 8B, . . . , and 8X, with the left digits representing a topic ID and the right digits representing an item ID in a topic.

As exemplary results of the foregoing process, the recommendation list 130 is generated for recommendation instance 1 and has four items 1A, 2A, 3C and 4D selected from topic 1, topic 2, topic 3, and topic 4 respectively. The recommendation list 140 is generated for recommendation instance 2 and has different combination: 1B, 2A, 5A and 8C selected from topic 1, topic 2, topic 5 and topic 8 respectively.

As will be appreciated by those skilled in the art, the present disclosure is not limited to any particular type of commodities but can be employed over any item. The commodities in the user's library and in the supplier's stock can be any conceivable type of commodities, such as books, clothes, furniture, food, toys, devices, appliances, health products, tickets, services, and human resources, to name a few. The suppliers adopting the present disclosure can be sellers, manufactures, marketers, retailers, licensors, renters, service providers, and etc. The present disclosure can be applied to businesses involving e-commerce or traditional commerce.

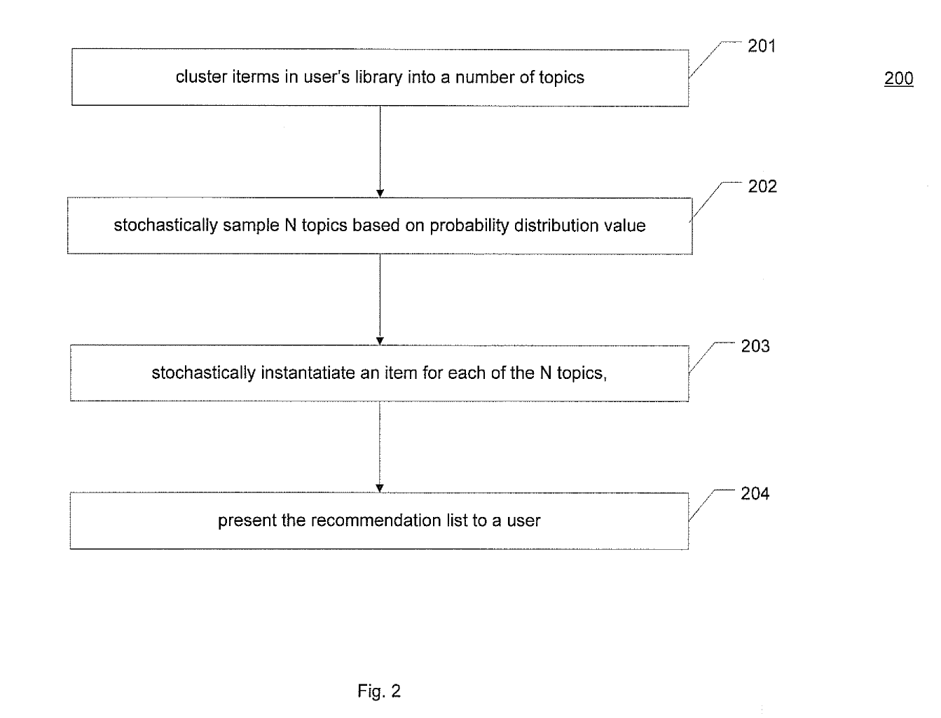

FIG. 2 is a flow chart depicting an exemplary computer implemented method 200 of generating a recommendation list by virtue of diversifying category selections and diversifying sample selections in accordance with an embodiment of the present disclosure. At 201, the book items in the user's library are clustered into a number of categories which correspond to the number of book topics in this embodiment. In some embodiments, the items are clustered based on their relatedness to each other. The relatedness can be calculated using a similarity measure or a combination of similarity measures that are well known in the art.

In some embodiments, a similarity function that can be used to calculate a similarity between item i and item j can be expressed as

$$s ( i , j ) = \frac{{\sum }_{u} {P}_{ui} {P}_{uj}}{\sqrt{{\sum }_{u} {P}_{ui}^{2}} \sqrt{{\sum }_{u} {P}_{uj}^{2}}}$$

where Pᵤᵢ is a non-zero value if there is information regarding the relationship between user u and item i (e.g., purchase or feedback).

The present disclosure is not limited to any particular clustering mechanism and any well know clustering method can be used. In some embodiments, an affinity propagation algorithm can be used to cluster a user's collection, where a preference parameter allows biasing the algorithm towards a smaller or larger number of clusters.

At 202, N topics are sampled stochastically based on probability distribution values assigned to the clusters, or topics, in the user's collection. The number N may correspond to the maximum number of topics that can be shown in a recommendation instance, which may be defined by the recommendation channel for example. In some embodiments, the N topics can be arranged in an order that reflects a user's preferences or implied purchase tendency on topics. For example, the first topic on the recommendation list may always correspond to the most preferred topic among the selected N topics.

The present disclosure is not limited to any particular probability distributions with respect to topic selection. In some embodiments, the probability distribution values can be determined using any feasible information that can indicates the user's manifested preference and future purchase tendency to respective topics, as will be discussed in greater details below.

At 203, a sample item is stochastically instantiated for each of the N topics in accordance with probability values assigned to the closeted items selected from the stock, as discussed with reference to FIG. 1. The present disclosure is not limited to any particular probability distributions with respect to sampling items for each selected topic.

At 204, a recommendation list is completed and presented to a user through a recommendation channel. Recommendation lists generated in accordance with the present disclosure can be presented to a user through various recommendation channels, such as emails, on-line shopping websites, pop-up advertisements, electronic billboards, newspapers, electronic newspapers, magazines, and etc. The foregoing process 202-204 can be repeated for each recommendation instance. Also, in response to new items added to a user's library, the foregoing process 201-204 can be repeated.

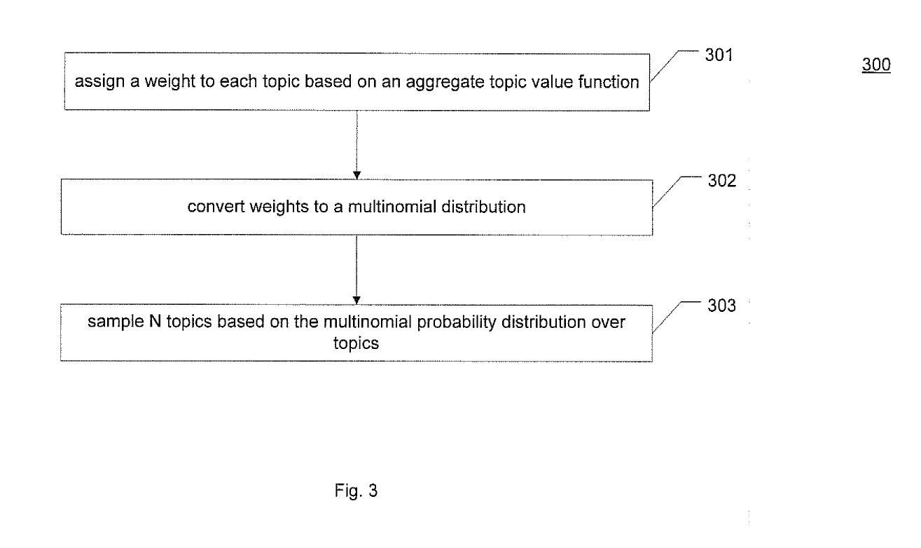

FIG. 3 is a flow chart illustrating an exemplary computer implemented method 300 of selecting recommendation topics by virtue of probability distribution in accordance with an embodiment of the present disclosure. At 301, a weight factor is assigned to each topic in a user's collection based on an aggregate topic value function that takes into account various characteristics associated with the topic. For example, the weight factors may be determined based on information suggesting the user's purchase tendency with respect to the topic, such as topic the topic/cluster size (e.g. the number of books of that topic), recency (e.g. time the last book in the topic was purchased), the monetary value that the user spent on that cluster (e.g. the revenue of all items in the topics), or any other characteristics alike.

At 302, the weight factors are converted to a multinomial distribution over the clusters in the user's collection. In some embodiments, a Softmax function can be used to perform the conversion, where the temperate parameter can be estimated empirically.

At 303, N topics are selected based on the multinomial probability distribution over the topics. In some embodiments, N can be equal to, less than, or greater than the number of clusters in the user's collection. Method 300 may be repeated for each recommendation instance and each recommendation list generation.

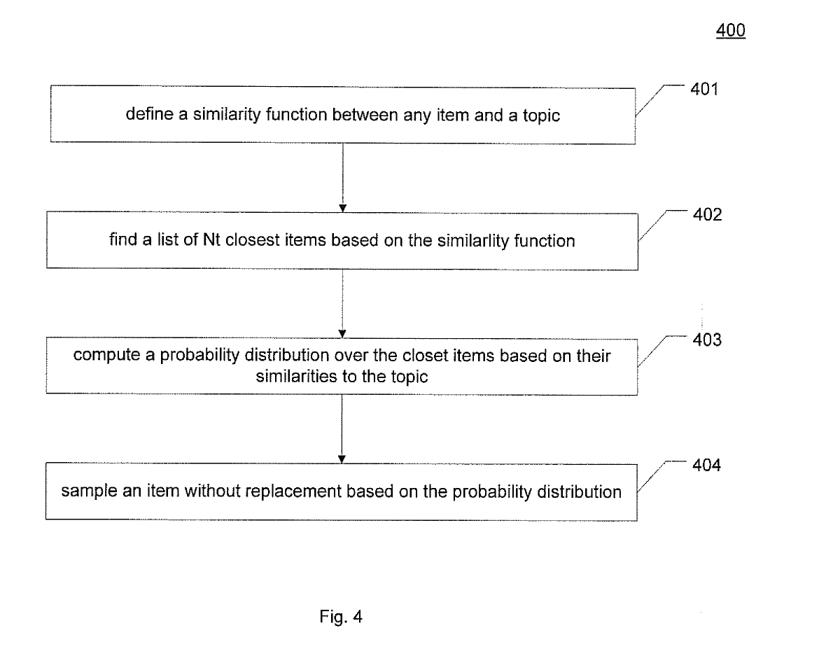

FIG. 4 is a flow chart illustrating an exemplary computer implemented method 400 of instantiating recommendation items for each selected category by virtue of probability distribution that is determined based on similarities in accordance with an embodiment of the present disclosure.

At 401, a similarity function s_{T}(i, t) can be defined as similarity between an item i in the stock and a topic t in the user's collection. s_{T}(i, t) can be any suitable similarity function that is well known in the art, such as the similarity function presented in Table 1. In some embodiments, s_{T}(i, t) may represent similarity between the item i and the closest item in the stock in topic t. Alternatively, s_{T}(i, t) may represent a sum of similarity between item i and all the books in the user's collection in topic t.

At 402, a list of Nt closet items with respect to topic t can be selected from the stock based on the similarity function s_{T}(i, t). At 403 a probability distribution Pₜ is computed over the closest items based on their similarities s_{T}(i, t) to the topic t. In some embodiments, Softmax can be used to determine the probability distribution Pₜ. At 404, an item is sampled or instantiated without replacement based on the probability distribution Pₜ. The foregoing 402 to 404 can be repeated for each of the selected N topics.

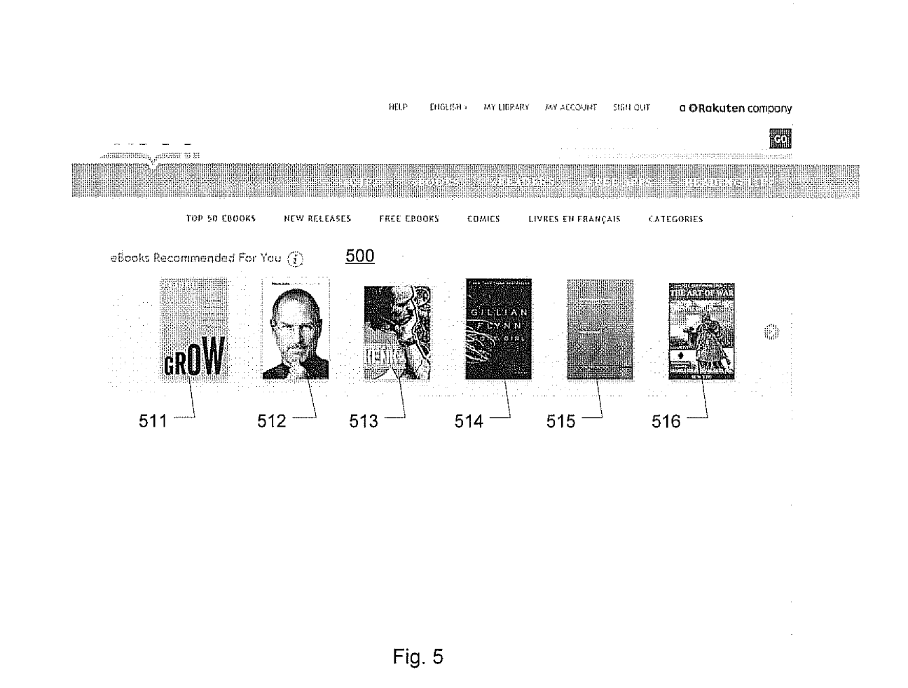

FIG. 5 is a diagram illustrating an exemplary on-screen graphic user interface (GUI) 413 that presents a recommendation list with diversified topics and diversified sample items in accordance with an embodiment of the present disclosure. The presented recommendation list 500 includes 6 books 511-516 that cover topics of business, biography, documentary, fiction, history, and etc. The topics and books are selected from the relevant books in the stock based on respective probability distributions. Thus, in a different recommendation instance, such as the user's next visit of the on-line store, a different recommendation list may be presented. In some embodiments, the recommended books in a list may be arranged in a pattern on the GUI and the pattern may reflect the importance of the categories to the user. However, in some other embodiments, the books can be arranged randomly to present diversified view to the user.

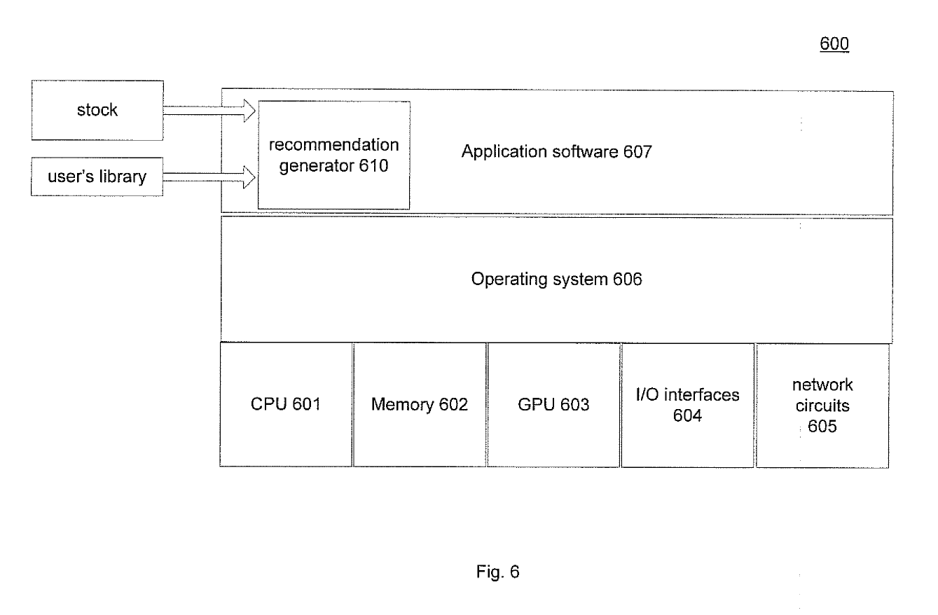

FIG. 6 is a block diagram illustrating an exemplary computing system 600 including an automatic recommendation list generator 610 in accordance with an embodiment of the present disclosure. The computing system comprises a processor 601, a system memory 602, a GPU 603, I/O interfaces 604 and network circuits 605, an operating system 606 and application software 607 including the automatic recommendation list generator 610 stored in the memory 602. When incorporating the user's configuration input and executed by the CPU 601, the automatic recommendation list generator 610 can produce recommendations in accordance with an embodiment of the present disclosure. The recommendation generator 610 may perform various functions and processes as discussed with reference to FIG. 1, FIG. 2, FIG. 3 and FIG. 4. The user configuration input may include a user's library and a supplier's stock for example, as discussed with reference to FIG. 5. As will be appreciated by those with ordinary skills in the art, the automatic recommendation generator 610 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically generating a recommendation list of commodities to a user, said method comprising:
accessing a user inventory comprising a collection of commodities in a plurality of categories of commodities;
partitioning said collection of commodities into a plurality of clusters of commodities, each cluster corresponding to a respective category of said plurality of categories;
assigning respective probability distribution values to said plurality of categories;
determining a selection set of categories from said plurality of categories for a recommendation instance based on probability distribution values of said plurality categories;
determining a respective sample commodity for each category of said selection set of categories to produce a plurality of sample recommendations, wherein said plurality of sample recommendations are selected from a stock of commodities; and
presenting said recommendation list identifying said plurality of sample commodities for said selection set of categories.

2. The computer implemented method of claim 1, wherein said assigning said respective probability distribution values comprises assigning a respective weight factor to each category of said plurality of categories, wherein said respective weight factor indicates a user's tendency of accessing commodities in a corresponding category, and wherein further said respective weight factor is dependent on a quantity, recency of purchase, and/or monetary values associated with commodities of said corresponding category in said collection of commodities.

3. The computer implemented method of claim 2, wherein said assigning respective probability distribution values further comprises converting said respective weight factor to a corresponding probability distribution value by use of a Softmax function.

4. The computer implemented method of claim 1 further comprising calculating similarities among commodities of said stock and of said collection, and wherein said partitioning said collection of commodities comprises partitioning said collection in accordance with corresponding similarities by use of a cluster algorithm.

5. The computer implemented method of claim 1 further comprising calculating similarities between commodities of said stock and commodities of said collection, and wherein said determining said respective sample commodity for each category comprises:
determining candidate sample commodities in said category in accordance with similarities between a respective candidate sample commodity and a corresponding category;
assigning respective recommendation probabilities to said candidate sample commodities in accordance with similarities between corresponding candidate sample commodities and corresponding categories; and
selecting said respective sample commodity stochastically from said candidate sample commodities in accordance with recommendation probabilities.

6. The computer implemented method of claim 1, wherein said collection of commodities comprises a collection of books that said user owns, and wherein said plurality of categories correspond to a plurality of book subjects.

7. The computer implemented method of claim 1, wherein said presenting comprises using a recommendation channel, and wherein said recommendation channel is selected from a group consisting of email, an on-line shopping website, a pop-up advertisement, and an electronic billboard, an electronic newspaper, and an electronic magazine.

8. The computer implemented method of claim 1, wherein items of said recommendation list is arranged in an order based on respective probability distribution values of said selection set of categories.

9. A non-transitory computer-readable storage medium embodying instructions that, when executed by a processing device, cause the processing device to perform a method of creating a recommendation list of commodities to a user, said method comprises:
accessing a user inventory comprising a collection of commodities;
accessing a stock of commodities;
identifying a plurality of categories associated with said collection of commodities;
stochastically selecting a set of categories from said plurality of categories for a recommendation event in accordance with a first probability distribution;
stochastically selecting respective selected commodities for each category in said set of categories for said recommendation event in accordance with a second probability distribution; and
during said recommendation event, presenting said recommendation list identifying selected commodities selected for said set of categories through a recommendation channel.

10. The non-transitory computer-readable storage medium of claim 9 further comprising:
determining a respective weight factor for each category of said plurality of categories based on a quantity of purchase, frequency of purchase, time of purchase, and/or monetary values associated with a corresponding category of commodities in said collection of commodities; and
determining said first probability distribution based on weight factors determined for said plurality of categories.

11. The non-transitory computer-readable storage medium of claim 10 further comprising determining a respective relevancy of each pair of commodities of said collection and said stock.

12. The non-transitory computer-readable storage medium of claim 11, wherein said selecting respective selected commodities for said each category comprises:
selecting a list of candidate sample commodities for a respective category in accordance with relevancies between commodities in said collection of commodities and commodities in said stock of commodities;
determining said second probability distribution based on relevancies associated with said list of candidate sample commodities;
selecting said selected commodities from said list of candidate sample commodities in accordance with said second probability distribution.

13. The non-transitory computer-readable storage medium of claim 11, wherein said identifying said plurality of categories comprises identifying said plurality of categories based on relevancies corresponding to said collection of commodities and in accordance with an affinity propagation algorithm.

14. The non-transitory computer-readable storage medium of claim 9, wherein said presenting a recommendation list comprises rendering a graphic user interface (GUI) comprising identifications of selected commodities on said recommendation list, wherein said identifications are arranged in a pattern based on said first probability distribution.

15. The non-transitory computer-readable storage medium of claim 9, wherein said collection of commodities comprise commodities selected from a group consisting of books, clothes, furniture, food, toys, electronic devices, appliances, health products, and combinations thereof.

16. A system comprising:
a processor;
a memory coupled to said processor and comprising instructions that, when executed by said processor, cause the processor to perform a method of determining recommendations of books with diversification, said method comprising:
accessing an inventory of a user library comprising a collection of books;
accessing an inventory of a stock of books;
partitioning said collection of books into a plurality of clusters of books, each cluster corresponding to a respective topic;
assigning a respective category probability distribution value to each topic of said collection of books;
selecting a plurality of sample topics for a recommendation instance based on respective category probability distribution values assigned for topics of said collection of books;
selecting respective sample books from said stock of books for each sample topic for said recommendation instance; and
during said recommendation instance, presenting a recommendation list identifying sample books for said plurality of sample topics.

17. The system of claim 16 further comprising determining a respective category probability distribution value based on said user's purchase tendency with respect to a corresponding topic, wherein said user's purchase tendency is determined based on a quantity, recency of purchase, and/or monetary values with respect to said corresponding topic.

18. The system of claim 16 further comprising determining similarities among books of said collection and said stock, and wherein said partitioning said collection of books comprises partitioning said collection of books in accordance with said similarities.

19. The system of claim 18 further comprising:
determining a respective plurality of candidate books for each topic of said plurality of sample topics in accordance with a similarity measure;
assigning a respective sample probability to each candidate book of said respective plurality of candidate books based on a ranking of similarities scores; and
selecting sample books from said respective plurality of candidate books in accordance with sample probabilities.

20. The system of claim 18, wherein items of said recommendation list are presented in an order based on category probability distribution values associated with said plurality of sample topics.
